(19) United States
(12) Patent Application Publication
(10) Pub. No.: US 2016/0059059 A1
(43) Pub. Date: Mar. 3, 2016

(54) APPARATUS AND METHOD TO MONITOR FOR FIRE EVENTS AND DYNAMICALLY ACTIVATE FIRE SPRINKLERS

(71) Applicant: Factory Mutual Insurance Company, Johnston, RI (US)

(72) Inventors: Yibing Xin, Sharon, MA (US); Kyle R. Burchesky, Portland, ME (US); Jaap De Vries, South Easton, MA (US); Harold Magistrale, Norwood, MA (US); Xiangyang Zhou, Sharon, MA (US); Stephen P. D'aniello, Franklin, MA (US)

(21) Appl. No.: 14/468,551

(22) Filed: Aug. 26, 2014

(51) Int. Cl. A62C 37/44; A62C 35/68

(52) U.S. Cl. CPC A62C 37/44; A62C 35/68

(57) ABSTRACT

A fire sprinkler system can include a plurality of fire sensors, each fire sensor adapted to generate an output signal indicative of a fire state; one or more controllers in communication with the plurality of fire sensors, the one or more controllers adapted to calculate one or more fire locations based on output signals received from one or more of the fire sensors; and a plurality of fire sprinklers in communication with the one or more controllers. The one or more controllers can be adapted to open one or more of the fire sprinklers based on the fire location calculated by the one or more controllers. Other features, as well as methods of controlling, suppressing, and/or extinguishing one or more fires, are also described.

### TECHNICAL FIELD

This patent application relates generally to the field of fire protection. More specifically, this patent application relates to apparatuses and methods that monitor for fire events, and dynamically activate fire sprinklers in response to detected fire events.

### BACKGROUND

In current fire sprinkler systems, each sprinkler typically includes a sensible element located on the sprinkler. The sensible element reacts to heat exposure, and causes activation of the sprinkler. Due to the temperature thresholds and response times associated with typical sensible elements, current sprinklers may not respond fast enough to certain fire events, e.g., those with fast fire spread rates, and those in very high storage. Also, fire-fighting agent sprays from one sprinkler may impinge on the sensible element of surrounding sprinklers, preventing the surrounding sprinklers from opening. This phenomenon, known as “sprinkler skipping,” can limit the effectiveness of current fire sprinkler systems.

### SUMMARY

According to an embodiment, a fire sprinkler system can comprise: a plurality of fire sensors, each fire sensor adapted to generate an output signal indicative of a fire state; one or more controllers in communication with the plurality of fire sensors, the one or more controllers adapted to calculate one or more fire locations based on output signals received from one or more of the fire sensors; and a plurality of fire sprinklers in communication with the one or more controllers. The one or more controllers can be adapted to open one or more of the fire sprinklers based on the fire locations calculated by the one or more controllers.

Embodiments can also provide a method of controlling, suppressing and/or extinguishing one or more fires. According to embodiments, the method can comprise: (a) monitoring for one or more fire events using a plurality of fire sensors; (b) calculating one or more fire locations based on output signals received from one or more of the fire sensors; and (c) opening one or more fire sprinklers based on the calculated fire locations.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 is a schematic representation of a fire sprinkler system according to an embodiment of the present invention.

FIG. 2 is a schematic representation of a fire sprinkler unit according to an embodiment of the present invention.

FIG. 3 is a flow diagram depicting steps of a method of controlling fires according to an embodiment of the present invention.

FIG. 4 is a side perspective view of an embodiment of fire sensors and a fire sprinkler unit mounted to a ceiling, according to an embodiment of the present invention.

FIG. 5 is another perspective view of the fire sensors and fire sprinkler unit of FIG. 4, shown looking upward at the ceiling.

### DETAILED DESCRIPTION

Various embodiments of the invention are discussed in detail below. While specific embodiments are discussed, it should be understood that this is done for illustration purposes only. A person skilled in the relevant art will recognize that other components and configurations can be used without departing from the spirit and scope of the invention.

As used herein, terms such as “front,” “back,” “left,” “right,” “upper,” “lower,” “top,” and “bottom” are used to describe positions relative to one another only and not to denote an absolute position. For example, an “upper portion” can become a “left,” “right,” or “lower” portion by rotating the item, although it can still be referred to as an “upper” portion of the item.

Embodiments of the present invention can provide a fire sprinkler system that monitors one or more fire events using multiple fire sensors, communicates the sensor signals between system components and external devices using either wired or wireless technologies, and calculates one or more fire locations based on sensor signals. According to embodiments, the system can activate sprinklers near the fire locations using wired or wireless communication between the fire sprinklers and the system control units (e.g., using a predetermined algorithm). As a result, the system may extinguish, suppress, or control the fire.

Embodiments of the present invention may provide protection against fire hazards that cannot be adequately protected by current fire sprinkler systems. Embodiments may include one or more of the following features, without limitation: multi-sensor detection technology; real-time fire monitoring algorithms to achieve early fire detection compared to traditional sprinklers; wired or wireless communication between fire sprinklers and system control units; the ability of the fire sprinklers to open (fully or partially) and close using automated technologies, such as solenoid valves; and implementation of sprinkler activation patterns to overcome sprinkler skipping issues.

Additionally or alternatively, embodiments of the invention can include the capability to activate and/or close one or more groups of sprinklers based on, for example: (i) the detection of one or more fire or fire extinguishment events; (ii) determination of one or more fire locations (e.g., spatial coordinates); and (iii) the development of the fire propagation. Embodiments of the systems described herein can provide advantages over traditional sprinklers, for example, due to the fast response times provided by, e.g., the use of multi-sensor technology, and/or the activation of sprinklers in a coordinated manner, and/or the activation of sprinklers ahead of fire propagation to protect unburned materials. Embodiments of the systems described herein can dynamically locate fire coordinates, and concentrate fire-fighting agent delivery in the vicinity of the fire. The fire-fighting agent can be, for example, water, foam, inert gas, chemical agent or the combination of these agents. This may limit fire-fighting agent damage caused to unburned material.

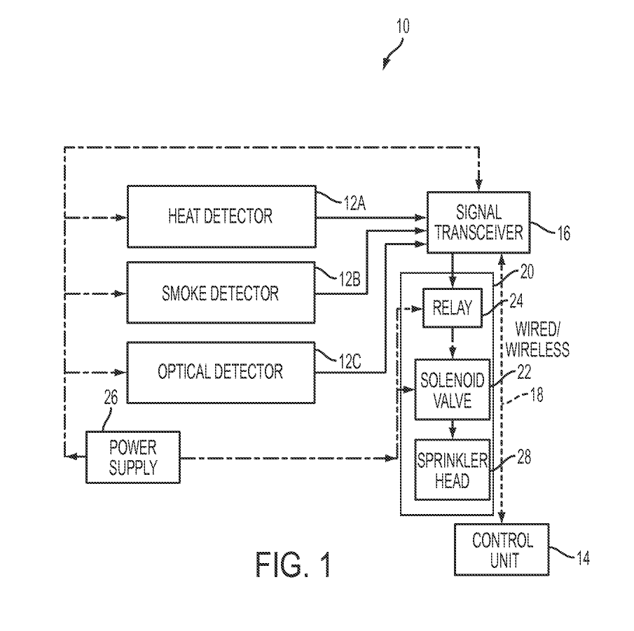

FIG. 1 is a schematic representation of a fire protection system according to an embodiment of the present invention. The system 10 can include a plurality of fire sensors 12 that are adapted to identify a fire state (e.g., presence or absence of fire, magnitude of fire, fire type, etc.), and generate an output signal indicative of the fire state. For example, thermocouple sensors output voltage to represent temperatures; the fire state can be determined by comparing the thermocouple output voltage to predetermined voltage thresholds. The fire state can be determined by comparing sensor signals to threshold values individually or in a combined manner. The system 10 can include a variety of different types of sensors 12, or alternatively, the same type of sensors 12 can be used throughout the system. According to embodiments, the fire sensors 12 can comprise heat detectors 12A, such as resistors or thermocouples, smoke detectors 12B, such as ionization or photoelectric devices, optical detectors 12C, such as infrared devices or ultraviolet devices or video imaging based devices, and/or other types of fire-detection sensors known in the art. The fire sensors 12 can monitor for a fire state, and relay information regarding the fire state to a control unit 14, such as a computer, programmable logic controller, mobile phone, or other electronic device, or any combination of multiple control units.

According to embodiments, the fire sensors 12 can communicate with the control unit 14 through wired or wireless communications. For example, according to a wireless embodiment, individual fire sensors 12 and/or groups of fire sensors 12 can be coupled to one or more transceivers 16 adapted to communicate with the control unit 14 via wireless protocol 18, for example, the IEEE 802.11S protocol or the peer-to-peer DigiMesh protocol. Alternatively, the transceiver 16 can communicate with the control unit 14 via wired communications. The control unit 14 can calculate a fire location based on the signals received from one or more of the fire sensors 12. The control unit 14 can then open one or more fire sprinkler units 20 based on the fire location calculated by the control unit 14. For example, according to embodiments, the control unit 14 can open a group of one or more sprinkler units 20 in the vicinity of the fire location. According to embodiments, the control unit 14 can predict the propagation of the fire in real-time, and open sprinkler units 20 accordingly.

Still referring to FIG. 1, each fire sprinkler unit 20 can include a relay 24 and a solenoid valve 22 adapted to open/close the sprinkler head 28 to control the discharge of fire-fighting agent from the sprinkler head 28. According to embodiments, the solenoid valve 22 can be controlled by a relay 24 that is in communication with the control unit 14, for example, through the transceiver 16. One of ordinary skill in the art will appreciate, however, that other electronic devices can be utilized to open/close the fire sprinkler units 20. Additionally, other electronic devices and architectures can be implemented to facilitate communications between the fire sensors 12, control unit 14, and fire sprinkler units 20. A power supply 26, such as a DC or AC power supply can be used to power the various system components shown in FIG. 1.

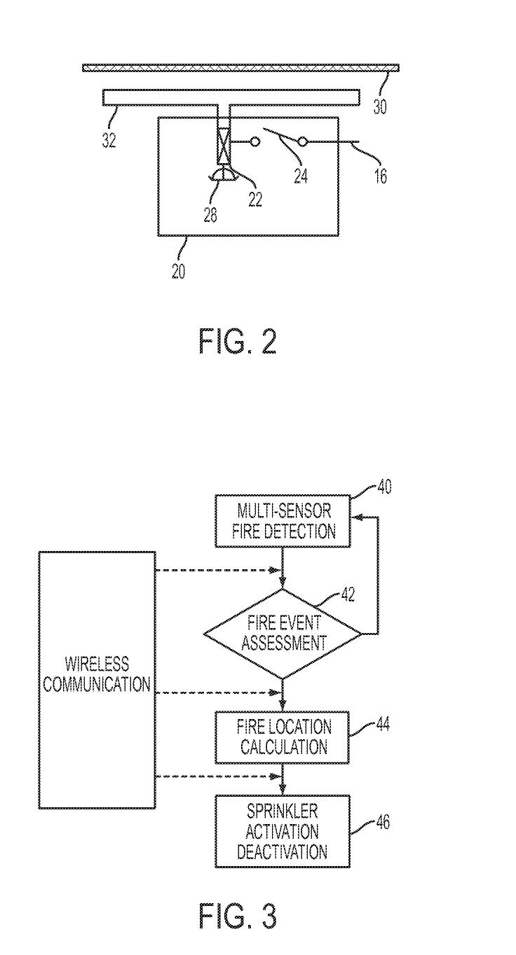

FIG. 2 is a schematic side view of a fire sprinkler head 28 and other components of the system 10, shown suspended from a ceiling 30. Each of the sprinkler units 20 can be coupled to a fire-fighting agent supply pipe 32 via a solenoid valve 22 that forms part of a larger fire-fighting system, e.g., within a residential, commercial, or industrial building, or within an outdoor system. According to embodiments, each sprinkler unit 20 can have one or more of the fire sensors 12 mounted on, or in, the sprinkler itself. Alternatively, some or all of the fire sensors 12 can be located remotely from the sprinkler units 20.

According to embodiments, the control unit 14 can partially or fully open one or more of the sprinkler heads 28 based on the fire state information received from the fire sensors 12, e.g., using wireless communications. According to embodiments, the control unit 14 can also partially or fully close certain sprinkler heads 28 in response to signals received from the fire sensors 12, e.g., as the fire is extinguished. This can avoid unnecessary discharge of fire-fighting agent in areas where the fire is adequately controlled or extinguished. More details about the opening and closing of the sprinkler units 20 will be provided below.

FIG. 3 depicts a flow diagram of a method according to the present invention. According to embodiments, the control unit 14 can perform one or more algorithms to achieve dynamic activation of the sprinkler units 20, e.g., by running computer software. According to embodiments, the algorithm(s) can integrate fire detection assessment, fire location calculation, and determination of sprinkler activation patterns. Referring to FIG. 3, the fire detection assessment function 40 constantly processes signals from multiple fire sensors 12, and declares a fire event 42, or if sprinkler units 20 have already been activated, declare fire extinguishment.

Upon detection of a fire event in step 42, the control unit 14 can process signals from the sensors 12 to compute the coordinates of the fire location in step 44. For example, the plurality of fire sensors 12 can be are arranged in a two- or three-dimensional array, and the control unit 14 can calculate the spatial coordinates of the fire location based on the signals received from the fire sensors 12. According to embodiments, the sensors 12 in the array can be located at regular distance intervals in the X and/or Y and/or Z directions, however, other configurations are possible.

In step 46, the control unit can determine a sprinkler activation pattern based on the calculated fire location (e.g., coordinates) and/or current fire development status (e.g., fire size) assessed from the output signals of the fire sensors 12. For example, ceiling flow correlations can be used to calculate the fire size. The results can be used to determine the fire state, the fire location, and open or close one or more sprinklers in the vicinity of the determined fire location. Once some of the sprinkler units 20 have been opened, the control unit 14 can also monitor for fire extinguishment, and partially or fully close all or some of the activated sprinkler units 20 to save fire-fighting agent and/or minimize fire-fighting agent damage, which can be significant in a fire. As part of the process of closing sprinkler units 20 after activation, the control unit 14 can re-calculate the fire location in step 44, and close some of the active sprinkler units 20 in response to the updated fire location, however, other embodiments are possible.

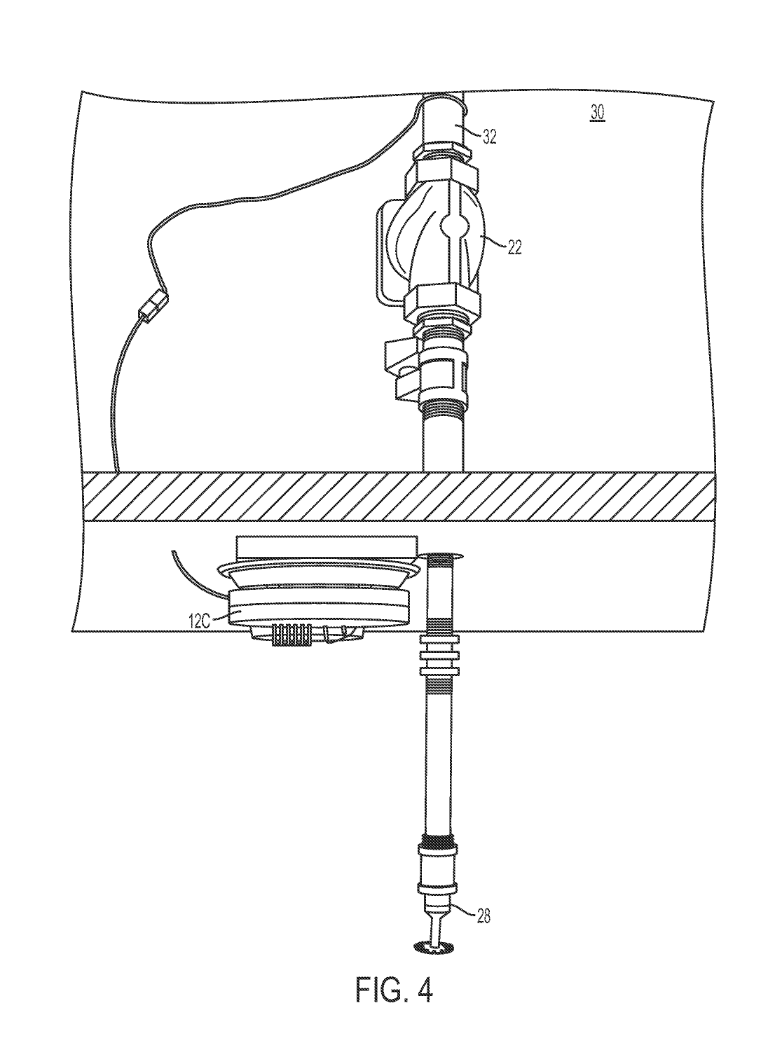

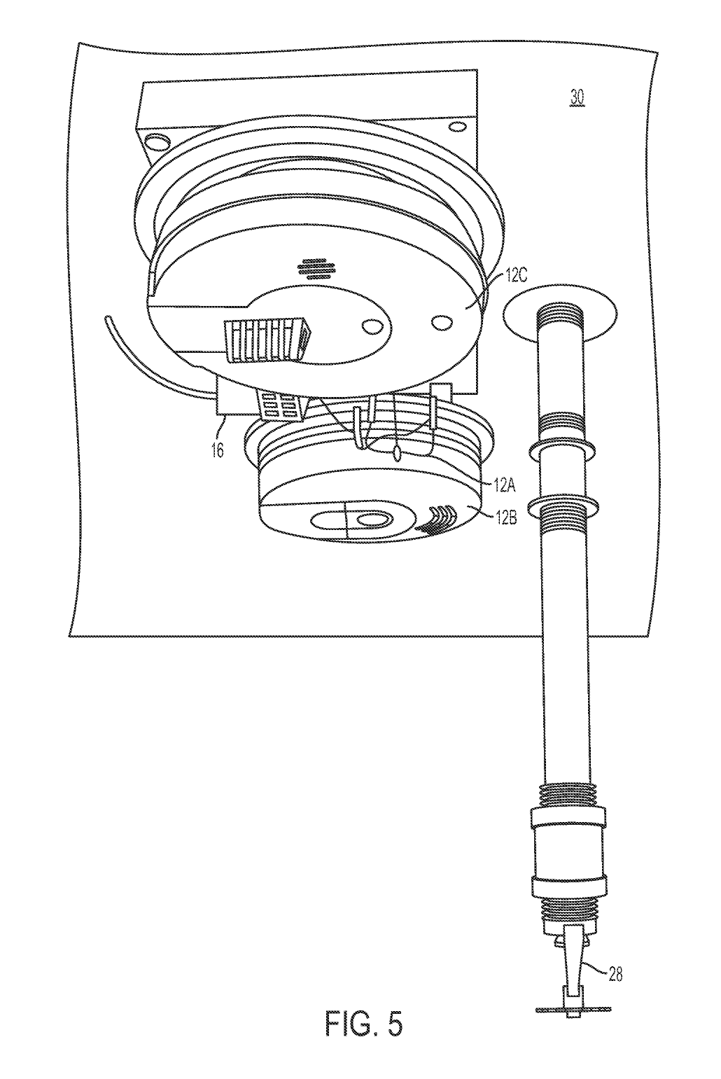

FIGS. 4 and 5 depict an embodiment of a fire sprinkler 20 and other components according to the present invention. As shown, the fire sprinkler head 28 can be located in fluid communication with a fire-fighting agent supply pipe 32. The valve 22 can be located upstream of the fire sprinkler head 28, as shown in FIG. 4, and can control flow of fire-fighting agent through the fire sprinkler head 28. The valve 22 can be in communication with the transceiver (not visible), e.g., through wires (shown) or wireless communications (not shown). The transceiver can also be in communication with the fire sensors, e.g., heat sensor 12A, smoke sensor 12B, and/or optical sensor 12C, as shown, e.g., through wires (shown) or wireless communication (not shown). The sensors 12 can relay information to the control unit (not shown) via the transceiver (not visible) via wireless communication, and the control unit can in turn control the fire sprinkler 28 (e.g., through the valve 22) via wireless communication with the transceiver.

Fire suppression tests have been performed using embodiments of the systems described herein. Test results have shown that early fire detection provided by the present invention can help reduce fire size upon sprinkler activation (opening) significantly, e.g., from about 2-3 MW to about 0.02-0.03 MW. Test results have also shown that systems described herein can significantly reduce the fire-fighting agent flux required to suppress fires, e.g., from about 41 mm/min to about 24 mm/min for water onto cartoned unexpanded plastic commodity, which is representative of a typical industrial product. Further, test results have shown that systems described herein dramatically improve the fire protection outcome as compare to prior art systems, e.g., from controlling the fire (holding the fire from growing larger) to extinguishing the fire (putting out the fire). The significance of these improvements can be much less fire damage, much less fire-fighting agent demand, less fire-fighting agent damage to unburned material, and much better protection than is possible with the prior art.

While various embodiments of the present invention have been described above, it should be understood that they have been presented by way of example only, and not limitation. For example, the invention can be applied to the measurement of many other particulates in an air stream and is not limited to the measurement of smoke. Thus, the breadth and scope of the present invention should not be limited by any of the above-described embodiments, but should instead be defined only in accordance with the following claims and their equivalents.

What is claimed:

1. A fire sprinkler system, comprising:
a plurality of fire sensors, each fire sensor adapted to generate an output signal indicative of a fire state;
one or more controllers in communication with the plurality of fire sensors, the one or more controllers adapted to calculate one or more fire locations based on output signals received from one or more of the fire sensors; and
a plurality of fire sprinklers in communication with the one or more controllers, wherein the controllers are adapted to open one or more of the fire sprinklers based on fire locations calculated by the one or more controllers.

2. The fire sprinkler system of claim 1, wherein the one or more controllers are adapted to close one or more of the fire sprinklers based on the output signals received from one or more of the fire sensors.

3. The fire sprinkler system of claim 1, wherein the one or more controllers are adapted to partially open the fire sprinklers.

4. The fire sprinkler system of claim 1, wherein the plurality of fire sensors are arranged in an array, and the one or more controllers are adapted to calculate spatial coordinates of one or more fire locations based on output signals received from the one or more fire sensors.

5. The fire sprinkler system of claim 1, wherein at least one of the fire sensors is located on each fire sprinkler.

6. The fire sprinkler system of claim 1, wherein at least one of the fire sensors is located remotely from the fire sprinklers.

7. The fire sprinkler system of claim 1, wherein the plurality of fire sensors are adapted to communicate wirelessly with the one or more controllers.

8. The fire sprinkler system of claim 1, wherein the plurality of fire sensors include at least one of an optical sensor, an infrared detector, an ultraviolet detector, a video imaging based device, a heat sensor, a smoke sensor, or a combination of the foregoing.

9. The fire sprinkler system of claim 1, wherein at least one of the fire sprinkler units comprises:
a solenoid valve movable between an open position corresponding to an activated state of the fire sprinkler, and a closed position corresponding to a deactivated state of the fire sprinkler;
wherein the solenoid valve is responsive to signals issued by the one or more controller.

10. The fire sprinkler system of claim 9, wherein the solenoid valve is adapted to receive signals from the one or more controllers via wireless communications.

11. A method of controlling, suppressing and/or extinguishing one or more fires, comprising:
(a) monitoring for one or more fire events using a plurality fire sensors;
(b) calculating one or more fire locations based on output signals received from one or more of the fire sensors; and
(c) opening one or more fire sprinklers based on the calculated fire locations.

12. The method of claim 11, further comprising:
performing step (b) only after detecting one or more fire events in step (a).

13. The method of claim 11, further comprising:
after detecting one or more fire events in step (a):
(d) monitoring for fire extinguishment using the plurality of fire sensors; and
(e) upon detecting fire extinguishment, at least partially closing at least some of the one or more fire sprinklers.

14. The method of claim 13, further comprising:
before at least partially closing at least some of the one or more fire sprinklers in step (e):
(f) re-calculating the fire locations based on output signals received from one or more of the fire sensors.

15. The method of claim 11, wherein the plurality of fire sensors are arranged in an array, the step (b) further comprising:
calculating spatial coordinates of the one or more fire locations based on output signals received from the fire sensors.

16. The method of claim 11, wherein the step of monitoring for one or more fire events is performed on one or more controllers, and the plurality of fire sensors are adapted to communicate wirelessly with the one or more controllers.

17. The method of claim 16, wherein the fire sprinklers are adapted to communicate wirelessly with the one or more controllers.

18. The method of claim 11, wherein at least one of the fire sensors is located on each fire sprinkler unit.

19. The method of claim 11, wherein at least one of the fire sensors is located remotely from the fire sprinkler units.

20. The method of claim 11, wherein the plurality of sensors include at least one of an optical sensor, an infrared detector, an ultraviolet detector, a video imaging based device, a heat sensor, a smoke sensor, or a combination of the foregoing.
